(19) United States
(12) Patent Application Publication
(10) Pub. No.: US 2026/0003892 A1
(43) Pub. Date: Jan. 1, 2026

(54) COMPUTING SYSTEM FOR IDENTIFYING AND USING BENCHMARK ATTRIBUTE TYPES AMONG SIMILAR ENTITIES IN DIFFERENT DATASETS

(71) Applicant: Intuit Inc., Mountain View, CA (US)

(72) Inventors: Daniel BEN DAVID, Hod Hasharon (IL); Kenneth Grant YOCUM, Encinitas, CA (US); Kumar KALLURUPALLI, Mountain View, CA (US); Jing HU, Mountain View, CA (US); Immanuel David BUDER, Mountain View, CA (US)

(73) Assignee: Intuit Inc., Mountain View, CA (US)

(21) Appl. No.: 18/759,744

(22) Filed: Jun. 28, 2024

(51) Int. Cl. G06F 16/28; G06F 16/248

(52) U.S. Cl. CPC G06F 16/285; G06F 16/248

(57) ABSTRACT

A method including identifying a target dataset within a number of datasets. Each of the datasets includes a number of similar attribute types. A first clustering model is applied, according to a similarity attribute type, to the datasets and the target dataset to generate a cluster of datasets. A second clustering model is applied to the cluster to generate a first subcluster and a second subcluster. The second clustering model clusters according to a performance attribute type, different than the similarity attribute type. A benchmark attribute type, comparable to a target attribute type of the target dataset, is identified in at least one of the first subcluster and the second subcluster. An outlier value for the benchmark attribute type of an outlier dataset in the at least one of the first subcluster and the second subcluster is identified. The benchmark attribute type and the outlier value are returned.

### BACKGROUND

A common computer-implemented task is to search for information in a data source or to request that target data be compared to the information in the data source. However, in some cases performing a meaningful automated search may be difficult, particularly with respect to comparing a target dataset to other, similar datasets when the benchmark for comparison is not readily known at the time a query is submitted.

For example, a business, B-Company may desire to benchmark the performance of B-Company against other companies. A data source containing datasets for many businesses is available. Each dataset for each business contains similar attribute types (e.g., name, location, income, expenses in various categories, etc.) However, comparing the performance of B-Company against all of the businesses in the data source is not meaningful, because the businesses are of all different business types and are of different sizes. For example, if B-Company were an independent fast-food restaurant, then comparing B-Company to a multi-national fast food chain is not helpful to benchmarking B-Company's performance. Likewise, comparing the fast food restaurant business of B-Company to independent houseware retailer businesses is not helpful to benchmarking B-Company's performance.

While it may seem trivial to limit B-Company's performance comparison query to other independent fast-food restaurants, doing so may not be practical or possible due to the nature of the data source or the datasets within the data source. For example, the information stored for the businesses in the dataset may not include labels which may be used to limit the comparison of B-Company to other companies that have a desired similarity to B-Company. In another example, the datasets in the data source may not specify that each company is a “restaurant,” or may not specify other parameters which could be used to determine a desirable subset of the available business datasets for comparison to B-Company.

Thus, a technical challenge exists in determining what attribute types of available datasets in a data source may be used as benchmarking attribute types when a query is received requesting that an entity be compared to similar entities. In other words, when a query requesting a comparison be made between datasets having similar attributes, a technical challenge may exist in identifying both: i) which attributes in the datasets to use for comparison as benchmarking attributes, and ii) which of the available entity datasets should be used when comparing the target entity dataset to other entity datasets in the data source.

### SUMMARY

One or more embodiments provide for a method. The method includes identifying a target dataset within a number of datasets. Each of the datasets includes a number of similar attribute types. The method also includes applying a first clustering model to the datasets and the target dataset to generate a cluster of datasets including fewer datasets than the datasets. The first clustering model clusters according to a similarity attribute type. The method also includes applying a second clustering model to the cluster of datasets to generate a first subcluster of the cluster of datasets and a second subcluster of the cluster of datasets. The second clustering model clusters according to a performance attribute type, different than the similarity attribute type. The method also includes identifying a benchmark attribute type, comparable to a target attribute type of the target dataset, in at least one of the first subcluster and the second subcluster. The similarity attribute type, the performance attribute type, the benchmark attribute type, and the target attribute type are members of the similar attribute types. The method also includes identifying an outlier value for the benchmark attribute type of an outlier dataset in the at least one of the first subcluster and the second subcluster. The method also includes returning the benchmark attribute type and the outlier value.

One or more embodiments provide for a system. The system includes a processor and a data repository in communication with the processor. The data repository stores a number of datasets. The data repository also stores a target dataset with the datasets. The data repository also stores a number of similar attribute types belonging to the datasets. The similar attribute types include: a similarity attribute type, a performance attribute type, different than the similarity attribute type, a benchmark attribute type, and a target attribute type belonging to the target dataset. The benchmark attribute type is comparable to the target attribute type. The data repository also stores a cluster of datasets including fewer datasets than the datasets. The data repository also stores a first subcluster of the cluster of datasets. The data repository also stores a second subcluster of the cluster of datasets. The data repository also stores an outlier dataset in the datasets. The data repository also stores an outlier value for the benchmark attribute type of the outlier dataset. The system also includes a first clustering model programmed, when executed by the processor, to generate the cluster of datasets by clustering the datasets according to the similarity attribute type. The system also includes a second clustering model programmed, when executed by the processor, to generate the first subcluster and the second subcluster by clustering the cluster of datasets according to the performance attribute type. The system also includes a server controller programmed, when executed by the processor, to identify the target dataset. The server controller is also programmed to identify the benchmark attribute type in at least one of the first subcluster and the second subcluster. The server controller is also programmed to identify the outlier value for the benchmark attribute type. The server controller is also programmed to return the benchmark attribute type and the outlier value.

One or more embodiments provide for another method. The method includes identifying a target dataset within a number of datasets. Each of the datasets includes a number of similar attribute types. The method also includes applying a first clustering model to the datasets and the target dataset to generate a cluster of datasets including fewer datasets than the datasets. Applying the first clustering model further includes comparing, to determine a number of distances, i) target values of the similar attribute types for the target dataset to ii) corresponding values of the similar attribute types for remaining datasets in the datasets. Applying the first clustering model further includes identifying the cluster of datasets as ones of the remaining datasets for which the distances satisfy a threshold distance. The method also includes applying a second clustering model to the cluster of datasets to generate a first subcluster of the cluster of datasets and a second subcluster of the cluster of datasets by clustering according to a performance attribute type different than the similarity attribute type. Applying the second clustering model further includes clustering the cluster of datasets according to selected attribute values of a first selected attribute type among the similar attribute types. The method also includes identifying a benchmark attribute type, comparable to a target attribute type of the target dataset, in at least one of the first subcluster and the second subcluster. The similarity attribute type, the performance attribute type, the benchmark attribute type, and the target attribute type are members of the similar attribute types. Identifying the benchmark attribute type includes identifying a first selected dataset in the first subcluster or the second subcluster. The first selected dataset includes a second selected attribute type of the similar attribute types that has a selected attribute value above a threshold value. Identifying the benchmark attribute type also includes specifying the second selected attribute type as the benchmark attribute type. The method also includes identifying an outlier value for the benchmark attribute type of an outlier dataset in the at least one of the first subcluster and the second subcluster. Identifying the outlier value includes identifying a highest benchmark value of the benchmark attribute type for a second selected dataset in the at least one of the first subcluster and the second subcluster. The outlier value includes the highest benchmark value. The method also includes adjusting a parameter of a server controller according to at least one of the benchmark attribute type and the outlier value.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for identifying benchmark attribute types among similar datasets, in accordance with one or more embodiments.

FIG. 3 shows an example of a dataflow for identifying benchmark attribute types among similar datasets and subsequently modifying a server controller accordingly, in accordance with one or more embodiments.

FIG. 4 shows a pictorial representation of a method for identifying benchmark attribute types among similar datasets, in accordance with one or more embodiments.

FIG. 5A and FIG. 5B show an example of a computing system and network environment, in accordance with one or more embodiments.

Like elements in the various figures are denoted by like reference numerals for consistency.

### DETAILED DESCRIPTION

One or more embodiments are directed to an improved computing system for identifying benchmark attribute types among similar datasets. As indicated above, a technical challenge exists in determining what attribute types of available datasets in a data source may be used as benchmarking attribute types when a query is received requesting that an entity be compared to similar entities. Also as indicated above, a technical challenge exists in determining which of the available entity datasets should be used when comparing the target entity dataset to other entity datasets in the data source.

As a specific example of the technical challenge, consider that a target business desires to compare itself to other businesses, the information about which is stored as datasets in a data source. While comparing the target business dataset to the datasets of the other businesses may seem straightforward, the returned comparison may not be useful. For example, comparing a target restaurant business to a retail business contained in the data source may not produce useful insights for the target restaurant business. In another example, comparing a target restaurant small business to restaurant large business may not produce useful insights for the target restaurant business. However, the datasets in the data source may not be searchable according to “restaurants,” because the datasets do not contain a label of “restaurant” for the businesses.

Furthermore, the specific attribute type most that would be most useful for the target business to compare to the other companies may not be known in advance. For example, while the overall expenses of a target business may be higher than related businesses, the specific expense types that cause the difference may not be apparent or known in advance. Still further, because the datasets store the values for the expense attribute types in terms of absolute dollar values, rather than according to performance ratios not stored in the data source, the information returned may be misleading.

One or more embodiments address these and other technical challenges. Briefly, one or more embodiments provide for generating a cluster of datasets along a similarity dimension in order to identify entities similar to the target entity. As explained below, the clustering process is part of identifying what constitutes a given entity to be similar to the target entity. Thus, the set of similar entities is generated as part of the clustering process. In a specific example, a cluster of datasets of peer businesses determined to be similar to the target business is generated.

Next, the cluster of similar entities is further clustered, in another clustering process, into two or more subclusters. The second clustering is performed along a different dimension than the similarity dimension. For example, the second dimension may be a performance dimension. Continuing the specific example, the peer businesses are further clustered into a high performing subcluster and a low performing subcluster.

Then, correlations between different attribute types between the two subclusters are drawn in order to identify which attribute types are most different from each other between the two subclusters. The identified attribute types may be referred to as benchmark attributes, as the attributes convey meaningful information to the target entity. Continuing the specific example, three expense categories (i.e., attribute types) are identified as being the most different between the high performing businesses and the low performing businesses. The three expense categories are identified as benchmark attributes. The values of the three expense categories (i.e., the values of the benchmark attributes) of the target business may be compared to the values of the corresponding benchmark attributes of either the high performing businesses, the low performing businesses, or both. In this manner, the target business receives specific, useful information regarding how similar successful (or unsuccessful) businesses perform relative to the target business.

The information then may be used to control other automated processes. For example, a server controller may be reprogrammed to impose tighter controls on expenses that correspond to the benchmark attributes.

The specific examples given above should not be construed to mean that one or more embodiments are directed to comparing businesses or making financial decisions. One or more embodiments are directed to a computer science issues with respect to identifying target entities to compare as well as identifying which attribute types should be compared when a request to compare a target entity to other entities is received. For example, one or more embodiments could have applications in other areas such as scientific research (e.g., comparing the properties of different stars), medical research (e.g., comparing patient studies), and many other applications. Thus, one or more embodiments may be characterized as enhancing a computing system to perform an improved search and comparison of datasets in a data source.

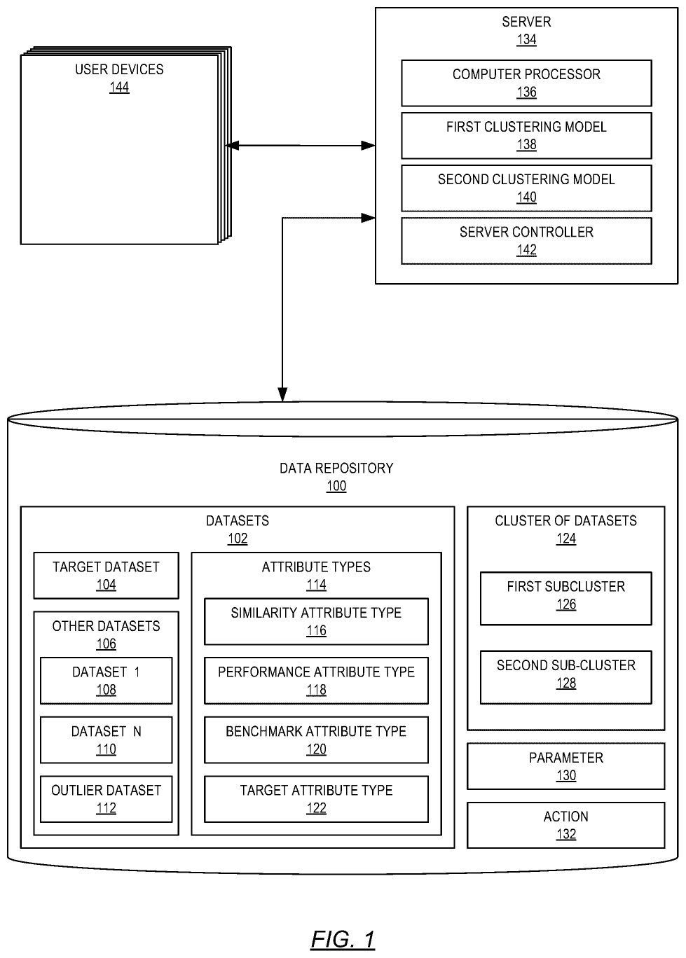

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) may store a number of datasets (102). The datasets (102) are each collections of data associated with an entity and describing the entity. The entity may be a subject of interest (e.g., a business, an object of scientific research, a person, etc.). The datasets (102) have similar attribute types. In other words, each of the datasets (102) includes at least some of the same attribute types in common among the datasets (102). The attribute types (114) are defined below.

For example, if the entity is a business, then each of the datasets (102) may include a number of attribute types including income, business size, expense, various expense categories, etc. While the values of the attribute types (114) may vary from business to business, each of the datasets (102) includes the attribute types. Some of the datasets (102) may include different attribute types, but each of the datasets (102) includes at least some similar attribute types. The presence of similar attribute types may complicate a search and comparison process, as described above, as initially it may not be apparent which of the datasets (102) should be compared or which of the attribute types may be a benchmark attribute type (120) (defined below) for a particular entity.

The data repository (100) may store a target dataset (104). The target dataset (104) is one of the datasets (102) which contains data that describes the entity of interest.

The data repository (100) also may store one or more other datasets (106), including dataset 1 (108) (a first dataset) and a number of additional datasets up to dataset N (110). The other datasets (106) are also ones of the datasets (102) that contain data that describe various different entities. The other datasets (106) are ones of the datasets (102) to which the target dataset (104) is to be compared.

The entities described by the other datasets (106) may be similar to each other at a high ontological level (e.g., the entities are businesses or, in the case of astronomical research, stars). However, the entities may be different from each other at lower ontological levels (e.g., business type, business size, different star types, etc.).

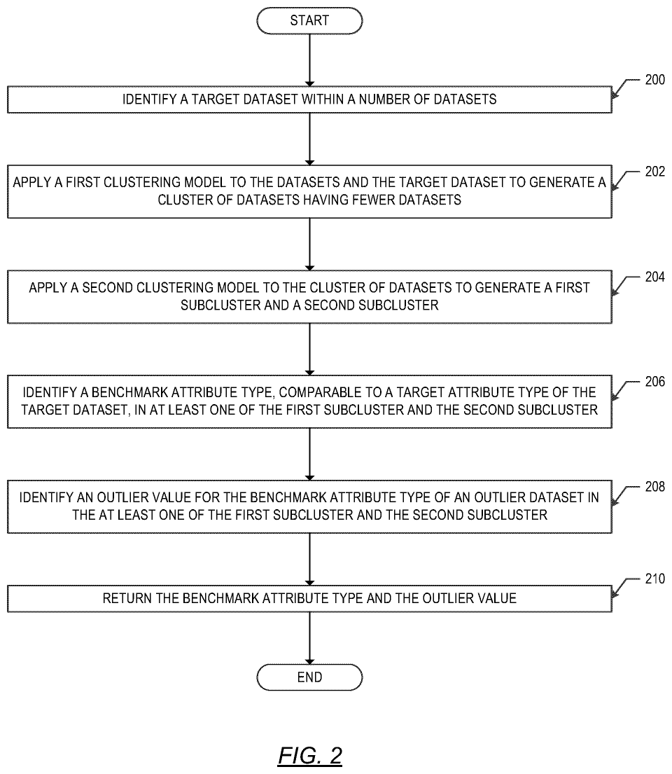

The other datasets (106) may include an outlier dataset (112). The outlier dataset (112) is a dataset identified as being comparable to the target dataset (104), and which also includes a value for an attribute type that is substantially different than a corresponding value for an attribute type in one of the subclusters, as described with respect to FIG. 2. The term “substantial” means that either the difference between the values of the corresponding attribute types exceed a threshold value, or that the difference between the values of the corresponding attribute types represent a grater difference than other differences between other attribute types when one of the datasets in a subcluster is compared to the target dataset (104). Stated differently, the outlier dataset (112) may contain a value for a benchmark attribute type (120), defined below, to which a corresponding attribute type in the target dataset (104) may be compared.

The data repository (100) also may store a number of attribute types (114). The attribute types (114) are categories of data contained within the datasets (102). For example, the attribute types (114) may be “business name,” “business type,” “income,” “rent expenses,” “travel expenses,” “percentage of carbon” contained in a star, or some other category of information. Again, as described above, many (possibly all) of the attribute types (114) exist in each of the datasets (102).

The attribute types (114) may have corresponding values. A value for an attribute type represents a quantitative assessment of the attribute type for a corresponding entity which the corresponding dataset describes. For example, if the entities described by the datasets (102) are stars, then an attribute type of the attribute types (114) may be “stellar mass,” and the attribute type value may be “two solar masses.”

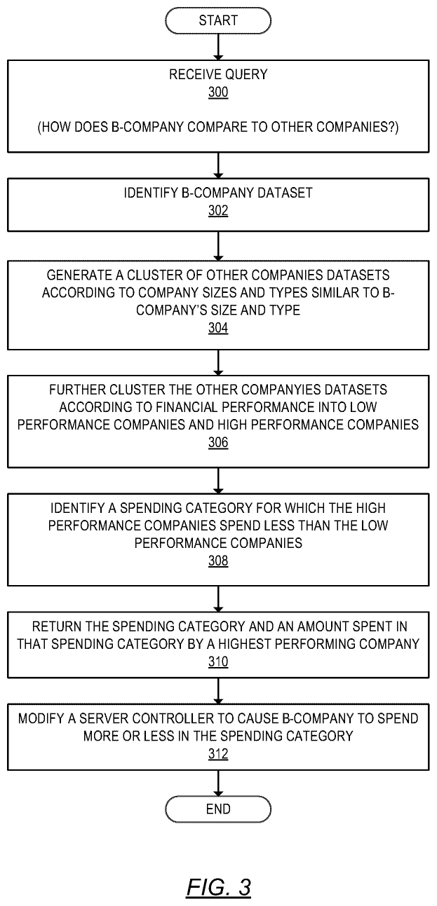

The attribute types (114) may be identified by different names for the purposes of identifying a use to which an attribute type is put. Thus, for the similarity attribute type (116), performance attribute type (118), benchmark attribute type (120), and target attribute type (122) described below, the names do not change the nature or value of the corresponding attribute type in the corresponding dataset. However, the names assist with understanding the purpose to which one of the attribute types (114) may be put at any given stage of the method of FIG. 2 or the dataflow of FIG. 3. For this reason, one of the attribute types (114) may be, at various times in a single implementation of the method of FIG. 2 or FIG. 3, any of the similarity attribute type (116), the performance attribute type (118), the benchmark attribute type (120), and the target attribute type (122).

The similarity attribute type (116) is an attribute type that is used to cluster the datasets (102) during a first clustering process using the first clustering model (138), defined below. The similarity attribute type (116) thus may be one of the attribute types (114) which may be used to establish that a particular entity is similar to another entity. The similarity attribute type (116) may be at a relatively high ontological level relative to other attribute types described below. For example, the similarity attribute type (116) may be “business size,” whereas another attribute type may be “travel expenses.” Because “business size” is ontologically at a higher level of description for a business than “travel sizes,” the “business size” attribute type is more likely to be a similarity attribute type. However, potentially any of the attribute types (114) may a similarity attribute type (116).

The performance attribute type (118) is an attribute type that is used to cluster the datasets (102) during a second clustering process using the second clustering model (140), defined below. The performance attribute type (118) thus may be one of the attribute types (114) which may be used to establish a difference between any two entities in the datasets (102) (i.e., a difference between the target dataset (104) and one of the other datasets (106), or between the dataset 1 (108) and the dataset N (110), or some other comparison). The performance attribute type (1187) (118) thus represents a quantitative difference among attribute types that measures a performance, or some other property, of the entities that is of interest to a user. For example, in the case of astronomical research, the performance attribute type (118) may represent the percentage of carbon in a star relative to other elements present in the star (e.g., five percent carbon) when the study is comparing carbon content in stars of similar types.

As mentioned above, the performance attribute type (118) may be used to separate the cluster of datasets (124) into the subclusters (e.g., the first subcluster (126) and the second subcluster (128) defined below). In other words, ones of the datasets in the cluster of datasets (124) having one range of values for the performance attribute type (118) may be clustered into the first subcluster (126), and ones of the datasets in the cluster of datasets (124) having another range of values in the performance attribute type (118) may be clustered into the second subcluster (128).

The benchmark attribute type (120) is one of the attribute types (114) that is used when comparing the target dataset (104) to one of the datasets in the first subcluster (126) or the second subcluster (128). The benchmark attribute type (120) contains information that is most likely to be useful to the user, and which was discovered as being the benchmark attribute type (120) when the method of FIG. 2 is applied. For example, if the entities are businesses, then the benchmark attribute type (120) may be “travel expenses” because the method of FIG. 2 identified that the attribute type “travel expenses” in the cluster of datasets (124) most closely relates to a reason why one of the businesses performs better than similar business represented by the cluster of datasets (124).

The target attribute type (122) is one of the attribute types (114) that is used to compare the target entity represented by the target dataset (104) and the entity represented by the outlier dataset (112) identified in one of the first subcluster (126) or the second subcluster (128). Thus, the target attribute type (122) is the same attribute type as the target attribute type (122); however, the target attribute type (122) refers to the identity of that attribute type in the target dataset (104) and the benchmark attribute type (120) refers to another identity of that attribute type in the outlier dataset (112). In other words, the same attribute type in the target dataset (104) and the outlier dataset (112) are compared to each other in order to benchmark the target entity with the outlier entity.

In a specific example, the identified target attribute type (122) in the outlier dataset (112) is “travel expenses.” The target attribute type (122) in this case is also “travel expenses,” but with respect to the target dataset (104). Thus, the value of “travel expenses” in the outlier dataset (112) is compared to another value of “travel expenses” in the target dataset (104).

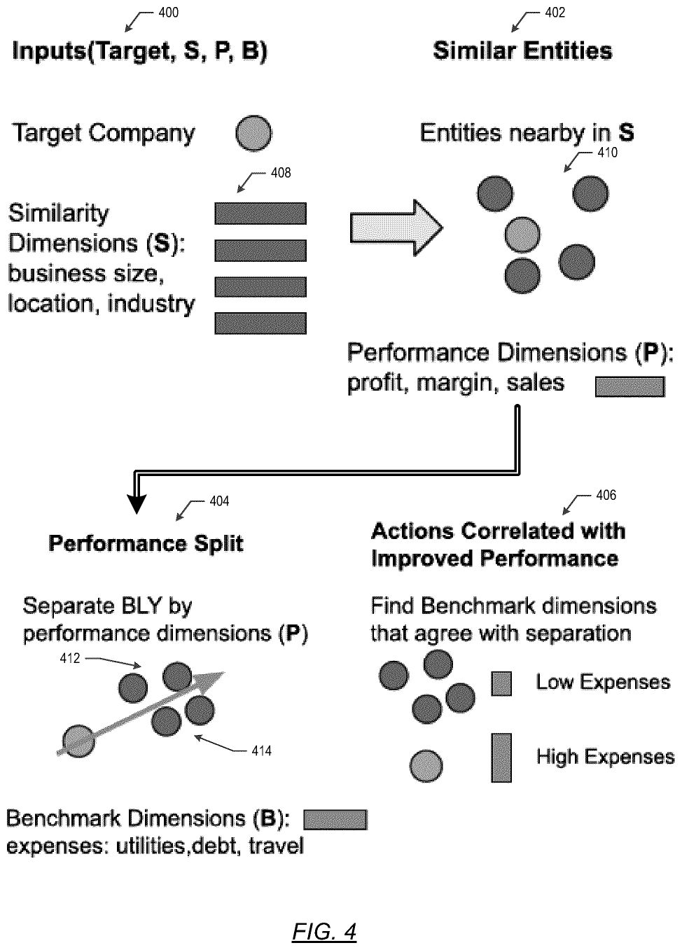

The data repository (100) also may store a cluster of datasets (124). The cluster of datasets (124) is the output of the first clustering model (138), described below. The cluster of datasets (124) contains fewer of the datasets (102) than a total number of the target dataset (104) stored in the data repository (100). Generation of the cluster of datasets (124) is described with respect to FIG. 2 and FIG. 3, and an example of the cluster of datasets (124) is shown in FIG. 4. Briefly, the cluster of datasets (124) is clustered according to the similarity attribute type (116).

The cluster of datasets (124) may include a first subcluster (126) and a second subcluster (128), and possibly more or fewer subclusters. The subclusters (i.e., the first subcluster (126) and the second subcluster (128)) are the output of the second clustering model (140), defined below. Each of the subclusters contains fewer of the datasets (102) than a total number of the datasets (102) contained in the cluster of datasets (124). Generation of the subclusters is described with respect to FIG. 2 and FIG. 3, and an example of the subclusters is shown in FIG. 4. Briefly, the subclusters are clustered according to the performance attribute type (118).

The data repository (100) also may store a parameter (130). The parameter (130) is a number, text, or computer readable code which the server controller (142), defined below, may use when performing the method of FIG. 2 or FIG. 3. Adjusting the parameter (130) changes the output of the server controller (142). Examples of the parameter (130) may include weights of a machine learning model, settings applicable to algorithms, etc.

The data repository (100) also may store an action (132). The action (132) is a command transmitted by the server controller (142), when executed by the computer processor (136), defined below. Thus, the action (132) is an execution of the server (134). Examples of the action (132) may include blocking or permitting functions of the server controller (142), presenting or displaying information to a user (e.g., displaying the values of the benchmark attribute type (120) with respect to the target dataset (104) and the outlier dataset (112)), storing information, passing information to another computer-implemented process, or some other action.

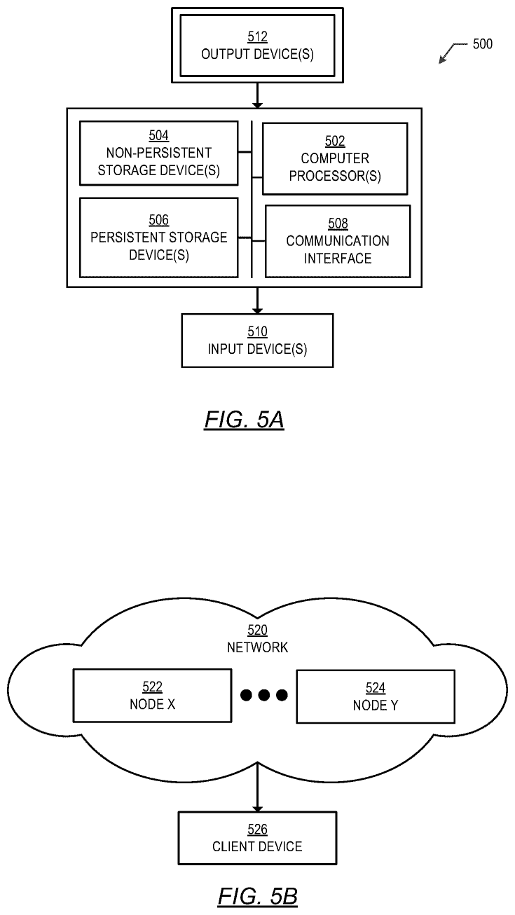

The system shown in FIG. 1A may include other components. For example, the system shown in FIG. 1A also may include a server (134). The server (134) is one or more computer processors, data repositories, communication devices, and supporting hardware and software. The server (134) may be in a distributed computing environment. The server (134) is configured to execute one or more applications, such as the first clustering model (138), the second clustering model (140), or the server controller (142). An example of a computer system and network that may form the server (134) is described with respect to FIG. 5A and FIG. 5B.

The server (134) includes a computer processor (136). The computer processor (136) is one or more hardware or virtual processors which may execute computer readable program code that defines one or more applications, such as the first clustering model (138), the second clustering model (140), and the server controller (142). An example of the computer processor (136) is described with respect to the computer processor(s) (502) of FIG. 5A.

The server (134) also may host a first clustering model (138). The first clustering model (138) is a clustering algorithm expressed in computer executable program code. For example, the first clustering model (138) may be a K-means clustering machine learning model. However, other clustering models may be used, such as a density-based spatial clustering of applications (DBSCAN) clustering algorithm, a Gaussian mixture model clustering algorithm, a balance iterative reducing and clustering using hierarchies (BIRCH) clustering algorithm, and others.

The server (134) also may host a second clustering model (140). The second clustering model (140) is also a clustering algorithm expressed in computer executable program code. In an embodiment, the second clustering model (140) is the same model as the first clustering model (138). In other words, the same clustering model may be used to generate the cluster of datasets (124), as well as the first subcluster (126) and second subcluster (128), by clustering datasets according to different attribute types at different clustering steps described with respect to FIG. 2. However, the second clustering model (140) also may be a different type of clustering model relative to the first clustering model (138).

The server (134) also may include a server controller (142). The server controller (142) is software or application specific hardware which, when executed by the computer processor (136), controls and coordinates operation of the software or application specific hardware described herein. Thus, the server controller (142) may control and coordinate execution of the first clustering model (138), the second clustering model (140), and the server controller (142). The server controller (142) may implement the methods shown in FIG. 2 or FIG. 3.

The system shown in FIG. 1 also may include one or more user devices (144). The user devices (144) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (144) are computing systems (e.g., the computing system (500) shown in FIG. 5A) that communicate with the server (134). The identification of the target dataset (104) may be received from one or more of the user devices (144). In another embodiment, one or more of the user devices (144) may be operated by a computer technician that services the various components of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for identifying benchmark attribute types among similar datasets, in accordance with one or more embodiments. The method of FIG. 2 may be implemented using the system of FIG. 1 and one or more of the steps may be performed on or received at one or more computer processors.

Step 200 includes identifying a target dataset within a number of datasets. A user entry received from a user device may identify the target dataset. For example, a query may be received that requests that the target dataset be compared to the other available datasets. Alternatively, another computer process may identify the target dataset to be compared to the other datasets.

Step 202 includes applying a first clustering model to the datasets and the target dataset to generate a cluster of datasets having fewer datasets than the number of datasets. The first clustering model clusters according to a similarity attribute type. The similarity attribute type may be pre-determined, may be specified by a user, or may be determined by a server controller as part of the clustering process.

For example, the first clustering algorithm may identify one of the attribute types among the various available datasets as being, on average, closer to each other than any other of the datasets. In a specific example, clustering may be performed using the first cluster model may include comparing, to determine a number of distances, i) target values of the similar attribute types for the target dataset to ii) corresponding values of the similar attribute types for remaining datasets in the datasets. Then, the cluster of datasets is identified as being as ones of the remaining datasets for which the distances satisfy a threshold distance. Other clustering methods also may be performed.

Step 204 includes applying a second clustering model to the cluster of datasets to generate a first subcluster of the cluster of datasets and a second subcluster of the cluster of datasets. The second clustering model clusters according to a performance attribute type, different than the similarity attribute type.

The clustering method used by the clustering model may depend on the type of clustering model used. In one example, clustering at step 204 may include clustering the cluster of datasets (established at step 202) according to selected attribute values of a selected attribute type among the similar attribute types.

Thus, for example, a performance attribute type may be identified by a user, by the server controller, or identified as being one of the attribute types having a greater variance in values relative to other attribute types. The second clustering model then may cluster the datasets in the cluster (established in step 202) into subclusters at step 204. In an embodiment, the subclusters may be high performing entities (as quantitatively determined by the attribute values of the performance attribute types for the corresponding datasets representing the entities) versus low performing entities (as quantitatively determined by the attribute values of the performance attribute types for the corresponding datasets representing the entities).

While the above example describes further clustering the cluster of datasets into two subclusters, more subclusters may be generated. For example, if two performance attribute types are selected, then four subclusters may be generated (high and low performing datasets for both performance attribute types). In another example, five subclusters may be present if a selected performance attribute type includes five different levels of performance. Other variations are possible.

Step 206 includes identifying a benchmark attribute type, comparable to a target attribute type of the target dataset, in at least one of the first subcluster and the second subcluster. The benchmark attribute type may be identified according to a number of different methods. For example, the benchmark attribute type may be an attribute type having the greatest variance in values among the datasets in the two subclusters. In another example, the benchmark attribute type may be received from a query requesting the target dataset be compared to the datasets.

In still another example, the benchmark attribute type may be identified by identifying a selected dataset in the first subcluster or the second subcluster. The selected dataset includes a selected attribute type of the similar attribute types that has a selected attribute value above a threshold value. The selected attribute type is identified as the benchmark attribute type. Still other variations are possible.

Step 208 includes identifying an outlier value for the benchmark attribute type of an outlier dataset in the at least one of the first subcluster and the second subcluster. The identifying the outlier value may be performed according to a number of different methods.

For example, identifying the outlier value may include identifying the highest benchmark value of the benchmark attribute type for a selected dataset in the at least one of the first subcluster and the second subcluster. The outlier value, in this case, may be the highest benchmark value. In other words, the outlier value is identified as the value of an attribute type in a dataset in a first subcluster that is furthest from the another value of the attribute type in another dataset in a second subcluster. Both such values may be identified for comparison to the target attribute type value (e.g., to compare the value of an expense type of a target business to the value of the expense type of a highest performing or lowest performing business).

In another example, identifying the outlier value may include identifying a number of different of benchmark values of the benchmark attribute type for datasets in the at least one of the first subcluster and the second subcluster. The benchmark values of the outlier attribute types that satisfy a threshold value are identified. In this case, the benchmark values include the outlier values.

Step 210 includes returning the benchmark attribute type and the outlier value. The benchmark attribute type and outlier value may be returned using a number of different techniques, depending on a purpose to which the benchmark attribute type and outlier value will be put.

For example, returning may include adjusting a parameter of a server controller according to at least one of the benchmark attribute type and the outlier value. Changing the parameter changes the output of the server controller, thereby changing a function of a computer.

In another example, returning may include predicting an action to change a target value of the target attribute type. The action may then be displayed to a user. For example, the outlier type may be an expense category and the outlier value the value for the highest performing peer business. In this case, the expense category (i.e., attribute type) and outlier value may be provided to another process that returns detailed information regarding transactions by the highest performing peer businesses in the expense category. Specific suggestions (e.g., changing vendors, eliminating certain expense types within an expense category, etc.) may be generated and transmitted to a user device as part of returning the benchmark attribute type and outlier value.

In still another example, other information may be returned to a user. For example, an identity of the outlier dataset may be stored, displayed, transmitted to another computer process, or otherwise returned. In yet another example, an identity of the entity represented by the dataset having the outlier value of the benchmark attribute type may be stored, displayed, transmitted to another computer process, or otherwise returned. Still other variations are possible.

The variations described above may be arranged in various combinations. For example, the following is an example of a variation of the method of FIG. 2.

The example includes identifying a target dataset within a number of datasets. Each of the datasets includes a number of similar attribute types.

The example also includes applying a first clustering model to the datasets and the target dataset to generate a cluster of datasets including fewer datasets than the datasets. Applying the first clustering model further includes comparing, to determine distances, i) target values of the similar attribute types for the target dataset to ii) corresponding values of the similar attribute types for remaining datasets in the datasets. Applying the first clustering model further includes identifying the cluster of datasets as ones of the remaining datasets for which the distances satisfy a threshold distance.

The example also includes applying a second clustering model to the cluster of datasets to generate a first subcluster of the cluster of datasets and a second subcluster of the cluster of datasets by clustering according to a performance attribute type different than the similarity attribute type. Applying the second clustering model further includes clustering the cluster of datasets according to selected attribute values of a first selected attribute type among the similar attribute types.

The example also includes identifying a benchmark attribute type, comparable to a target attribute type of the target dataset, in at least one of the first subcluster and the second subcluster. The similarity attribute type, the performance attribute type, the benchmark attribute type, and the target attribute type are members of the similar attribute types.

Identifying the benchmark attribute type includes identifying a first selected dataset in the first subcluster or the second subcluster. The first selected dataset includes a second selected attribute type of the similar attribute types that has a selected attribute value above a threshold value. The second selected attribute type is specified as the benchmark attribute type.

The example also includes identifying an outlier value for the benchmark attribute type of an outlier dataset in the at least one of the first subcluster and the second subcluster. Identifying the outlier value includes identifying the highest benchmark value of the benchmark attribute type for a second selected dataset in the at least one of the first subcluster and the second subcluster. The outlier value includes the highest benchmark value.

The example includes adjusting a parameter of a server controller according to at least one of the benchmark attribute type and the outlier value. In this manner, the operation of a computer may be improved or otherwise adjusted using one or more embodiments.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3 shows an example of a dataflow for identifying benchmark attribute types among similar datasets and subsequently modifying a server controller accordingly, in accordance with one or more embodiments. The dataflow shown in FIG. 3 may be implemented using the system of FIG. 1, and may be a specific example of the method of FIG. 2.

At step 300 a query is received. The query is to compare the performance of a company, B-Company, to similar companies. B-Company is an independent fast food restaurant business.

The available data source describing companies to compare contains datasets for many different companies. Each of the datasets reflect information for a different company. Each of the datasets are similar datasets in that each of the datasets include the same attribute types, such as income, expenses, number of employees, number of years operating, etc.

However, at the time the query is received, it is not known which attributes in the datasets should be used for comparison as benchmarking attributes. Furthermore, at the time the query is received, it is not known which of the available entity datasets should be used when comparing the target entity dataset to other entity datasets in the data source. However, the dataflow of FIG. 3 addresses the technical challenges presented by performing a meaningful benchmark comparison of B-Company to other companies when the benchmark attributes, and the subset of entity datasets to which B-Company should be compared, are not initially known.

At step 302, the dataset for B-Company is identified in the data source. The dataset for B-Company contains a number of attribute types. Each of the attribute types represents a type of information about B-Company, such as income, expenses, number of employees, number of years operating, etc. The values for the attribute types represent the specific information pertaining to B-Company.

However, as indicated above, directly comparing B-Company to all of the companies in the data source is not appropriate because many of the companies are not comparable in a way that is meaningful to B-Company. In particular, comparing B-Company to much larger or much smaller companies is not helpful to B-Company understanding which attribute types may constitute benchmark attribute types (e.g., whether comparing income is a good benchmark to compare B-Company to another company). Furthermore, comparing B-Company to companies other than different independent fast food restaurants may not be helpful to B-Company. However, the attributes available in the various datasets do not indicate which datasets in the data source correspond to independent fast food restaurants.

To address these issues, step 304 includes generating a cluster of other companies' datasets according to company sizes and types similar that are similar to B-Company's size and type. Step 304 narrows the number of datasets available in the data source to the cluster of datasets.

First, designated attribute types are selected for generating the cluster. While the label of “independent fast food restaurant” is not an attribute type in any of the datasets, it may be determined which attribute types will approximate the label of “independent fast food restaurant” within the available datasets. For example, a user may designate the attribute types. Alternatively, the input “independent fast food restaurant” may be submitted to a large language model along with a prompt to select one or more of the available attribute types in the datasets as most closely approximating the input.

In the example of FIG. 3, the available attribute types “income,” “size,” and “type” are used to approximate the ideal label of “independent fast food restaurant.” Thus, the server controller determines the distances between the “income” of the target company (i.e., B-Company) and other companies in the data source, the “size” of the target company (i.e., B-Company) and the other companies in the data source, and between the “type” of the target company and the other companies represented by the other datasets in the data source. The distances may be determined by directly comparing numbers (i.e., comparing the numerical size difference between B-Company and the other datasets). The distances also may be determined by determining a semantic distance between terms (i.e., using a language model to determine numerical semantic distances between the “type” of B-Company and the “types” of the other datasets).

Three distances may be determined for each comparison, namely the distances between the “income” attribute types, the distances between the “size” attribute types, and the distances between the “type” attribute types. The three distances may be combined into a combined distance. The combined distance may be compared to a threshold distance.

In the alternative, one attribute type may have been used. For example, the one attribute type could have been “income.” Thus, the businesses represented by the datasets in the cluster may all have similar incomes.

The clustering model may use the combined distances and the threshold distance to cluster the available datasets into the cluster of datasets. Thus, stated in the alternative, the cluster contains those datasets that have an average distance within a threshold distance.

Step 306 then includes further clustering the other companies' datasets according to financial performance into low performance companies and high performance companies. Financial performance may be a combination of values of different attribute types for both B-Company and the other companies in the cluster identified at step 304, or may be a direct comparison if one of the attribute types in the datasets is “financial performance.”

Note that financial performance is not the benchmark attribute type. The financial performance metric, however, may be used to further cluster the cluster identified at step 304 as part of the process of identifying the benchmark attribute type. In other words, what is of interest is comparing B-Company to high performing companies, or to low performing companies (or both). However, the benchmark attribute to be used to compare B-Company to other companies in a meaningful way has yet to be identified. The following step (i.e., Step 308) will be used to identify the benchmark attribute.

Step 308 then includes identifying a spending category for which the high performance companies spend less than the low performance companies. From step 304, the companies in the cluster already are known have similar incomes to B-Company (as company income was one of the attribute types used to establish the first cluster). However, at step 308 some of the companies in the cluster are subclustered into high performing companies and low performing companies. The differences between the companies may now be used to identify the benchmark attribute type. Because the companies have similar incomes, the differences between the high performing companies and low performing companies are derived from spending habits. Thus, as indicated above, step 308 identifies a spending category which, at least in part, establishes the difference in performance.

For example, assume the available attribute types in the datasets include “travel expenses,” “advertising expenses,” and “rent.” The values of the three attribute types among the various datasets (i.e., the amounts the different companies spend in these three categories) are compared. The server controller selects one or more of the available attribute types related to spending that are most different from each other. For example, the majority of high performing companies have lower rents and lower advertising expenses than the majority of low performing companies, but may have higher travel expenses than the lower performing companies. Between rent and advertising expenses, the difference between the values of the two attribute types is greatest in the area of advertising expenses.

Thus, the attribute type “advertising expenses” is identified as a benchmark attribute type. Specifically, because “advertising expenses” is the largest single category of performance difference between high and low performing companies in the cluster of datasets, “advertising expenses” may be used as a benchmark attribute type to compare B-Company to other companies.

If desired, multiple benchmark attribute types may be returned. For example, “rent” also may be returned as a benchmark attribute type, as a threshold measurable difference existed in the values of “rent” between the high and low performing companies. In another example, “travel expenses” may be returned as a benchmark attribute type, as a threshold measurable difference existent in the values of “travel expenses” between the high and low performing companies.

Step 310 includes returning the spending category and the amount spent in that spending category by a highest performing company. For example, the highest performing company in the high performance subcluster, may be identified. The benchmark attribute types of “travel expenses,” “advertising expenses,” and “rent” are returned as the spending categories. The values for the categories are presented.

A user then may directly compare the amount of money that B-Company spends in “travel expenses,” “advertising expenses,” and “rent” relative to comparable amounts spent by the highest performing company. The user may then readily see that B-Company may be able improve financial performance by reducing advertising expenses and reducing rent, but (counterintuitively) by increasing travel expenses. The user may perform further research on the high performing company in order to determine how the high performing company was able to lower advertising expenses and rent, and why higher travel expenses may have improved the overall financial performance of the high performing company.

In another embodiment, other analyses may be performed. For example, now that the benchmark attribute types are known, the average of the values of the attribute types for the datasets in the cluster generated at step 304 may be compared to the corresponding values of B-Company. Thus, the user may understand how B-Company compares to other companies with respect to the three benchmark attribute types (e.g., a ranked percentile of performance). Further analysis may compare B-Company to the subclusters of datasets in order to determine whether B-Company is closer to the high performing companies or closer to the low performing companies. Still other analyses are possible once the benchmark attribute types have been identified.

Step 312 includes modifying a server controller to cause B-Company to spend more or less in the spending category. For example, assume that B-Company uses a server controller to approve advertising expenses. B-Company may adjust the server controller to reduce the total budget which the server controller may access to pay for advertising expenses. Similarly, B-Company may adjust the server controller to increase the difficulty of generating approval for advertising expenses. In this manner, B-Company may automatically reduce advertising expenses, and thereby improve the overall financial performance of B-Company.

When FIG., 3 is considered as a whole, it may be seen that, initially, while much data was available in the datasets, identifying the companies to which B-Company could be compared, and then identify the attribute types which would generate meaningful information to B-Company, was not apparent. However, the data flow of FIG. 3, as an example of the method of FIG. 2, shows how B-Company could be compared to companies similar enough to B-Company to generate useful information to B-Company, then then further how to identify which attribute types serve as the most meaningful benchmark attribute types for B-Company.

FIG. 4 shows a pictorial representation of a method for identifying benchmark attribute types among similar datasets, in accordance with one or more embodiments. At step 400, the inputs are provided to a server controller. The inputs includes a target dataset (408) for the target entity.

At step 402, a cluster of datasets relating to other companies is generated. The cluster (410) include those datasets that are nearby in measured distance according to a similarity dimension(S). The similarity dimension is a set of attribute types which permit the target company to be compared to other companies, as described with respect to FIG. 3.

At step 404, the cluster (410) is subdivided into two subclusters, subcluster (412) and subcluster (414). The clustering that generates the subclusters is performed according to performance dimensions (P). The performance dimensions are sets of attribute types which permit the other companies to be compared to each other along attribute types defined to be performance related (e.g., income attribute types, different expense attribute types, etc.).

Additionally, at step 404, benchmark dimensions (B) are identified. The benchmark dimensions are sets of attribute types that are identified as being benchmark attributes, as described with respect to FIG. 3. In the example, the expense attribute types “utilities,” “debt,” and “travel” are identified as being benchmark attributes, and thus form the benchmark dimensions.

At step 406, suggested actions correlated with improved performance are returned. Specifically, the benchmark dimensions and the corresponding values of the benchmark dimensions are returned. Identities of the other companies also may be returned. The benchmark dimensions, corresponding values, and identities of the other companies may be used to formulate a specified action for a server controller to take. For example, the server controller may be programmed to impose tighter controls on future authorizations for expenses in the benchmark dimensions. In another example, suggested actions for reducing the expenses in the benchmark dimensions may be presented to a user.

For example, referring again to FIG. 4, consider the task of recommending expenses to reduce. Without one or more embodiments, a naïve solution would rank expenses by an average monthly spend. However, those top expenses may be reasonable given the company's industry, making such advice misguided. Using one or more embodiments, instead expenses are found that are abnormally high for the target company relative to a set of successful peers (similar companies) that have higher margins and better cash flow.

Thus, given the target company identity and similarity dimensions, one or more embodiments may first find a cluster of nearby companies. One or more embodiments then splits the nearby entities into high and low-performing groups. One or more embodiments then compare the action dimensions between the two groups, determining those correlated with higher performance.

One or more embodiments thereby enables a range of analysis for finding actionable insights or advice for companies. For example, consider the following examples in which the performance dimensions (P) are defined and the benchmark dimensions (B) are found.

For invoice suggestions, P may be is the time to be paid. In this case, B includes personalized subject lines, reminder frequency, and discount rate.

For peer financial ratios, P may be a profit margin. In this case, B includes company financial ratios, such as a current ratio financial. The financial ratios may be returned, together with a quantitative assessment of where the company stands with respect to successful, or unsuccessful peer companies.

For expense suggestions, P again may be a profit margin. However, in this case, the benchmarks B are the companies' expenses. A ranked list of expenses for the target company may be returned that are higher than similar successful per companies.

For key performance indicator suggestions, P may be revenue. In this case, B is a list of key performance indicators. A set of key performance indicators are returned that are markedly different for the target company relative to high performing peers.

Many other examples are possible. Furthermore, one or more embodiments are not limited to applications with respect to comparing businesses to each other. One or more embodiments may be used to compare other types of datasets, such as different star types (astronomical research comparing stars), medical research (comparing different patient studies), and other data science applications.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
identifying a target dataset within a plurality of datasets, wherein each of the plurality of datasets comprises a plurality of similar attribute types;
applying a first clustering model to the plurality of datasets and the target dataset to generate a cluster of datasets comprising fewer datasets than the plurality of datasets, wherein the first clustering model clusters according to a similarity attribute type;
applying a second clustering model to the cluster of datasets to generate a first subcluster of the cluster of datasets and a second subcluster of the cluster of datasets, wherein the second clustering model clusters according to a performance attribute type, different than the similarity attribute type;
identifying a benchmark attribute type, comparable to a target attribute type of the target dataset, in at least one of the first subcluster and the second subcluster,
wherein the similarity attribute type, the performance attribute type, the benchmark attribute type, and the target attribute type are members of the plurality of similar attribute types;
identifying an outlier value for the benchmark attribute type of an outlier dataset in the at least one of the first subcluster and the second subcluster; and
returning the benchmark attribute type and the outlier value.

2. The method of claim 1, wherein returning the benchmark attribute type and the outlier value comprises:
adjusting a parameter of a server controller according to at least one of the benchmark attribute type and the outlier value.

3. The method of claim 1, wherein returning the benchmark attribute type and the outlier value further comprises:
predicting an action to change a target value of the target attribute type; and
presenting the action.

4. The method of claim 1, further comprising:
returning an identity of the outlier dataset.

5. The method of claim 1, wherein applying the first clustering model further comprises:
comparing, to determine a plurality of distances, i) target values of the plurality of similar attribute types for the target dataset to ii) corresponding values of the plurality of similar attribute types for remaining datasets in the plurality of datasets; and
identifying the cluster of datasets as ones of the remaining datasets for which the plurality of distances satisfy a threshold distance.

6. The method of claim 1, wherein applying the second clustering model comprises clustering the cluster of datasets according to selected attribute values of a selected attribute type among the plurality of similar attribute types.

7. The method of claim 1, wherein identifying the outlier value comprises one of:
identifying a highest benchmark value of the benchmark attribute type for a selected dataset in the at least one of the first subcluster and the second subcluster, wherein the outlier value comprises the highest benchmark value; and
identifying a plurality of benchmark values of the benchmark attribute type for datasets in the at least one of the first subcluster and the second subcluster, wherein the plurality of benchmark values satisfy a threshold value, and wherein the plurality of benchmark values comprise the outlier value.

8. The method of claim 1, wherein identifying the target dataset comprises:
receiving a query requesting the target dataset be compared to the plurality of datasets.

9. The method of claim 1, wherein identifying the benchmark attribute type comprises:
receiving the benchmark attribute type from a query requesting the target dataset be compared to the plurality of datasets.

10. The method of claim 1, wherein identifying the benchmark attribute type comprises:
identifying a selected dataset in the first subcluster or the second subcluster, wherein the selected dataset comprises a selected attribute type of the plurality of similar attribute types that has a selected attribute value above a threshold value, and
specifying the selected attribute type as the benchmark attribute type.

11. A system comprising:
a processor;
a data repository in communication with the processor and storing:
a plurality of datasets,
a target dataset with the plurality of datasets,
a plurality of similar attribute types belonging to the plurality of datasets, wherein the plurality of similar attribute types include:
a similarity attribute type,
a performance attribute type, different than the similarity attribute type,
a benchmark attribute type, and
a target attribute type belonging to the target dataset, wherein the benchmark attribute type is comparable to the target attribute type,
a cluster of datasets comprising fewer datasets than the plurality of datasets,
a first subcluster of the cluster of datasets,
a second subcluster of the cluster of datasets,
an outlier dataset in the plurality of datasets, and
an outlier value for the benchmark attribute type of the outlier dataset;
a first clustering model programmed, when executed by the processor, to generate the cluster of datasets by clustering the plurality of datasets according to the similarity attribute type;
a second clustering model programmed, when executed by the processor, to generate the first subcluster and the second subcluster by clustering the cluster of datasets according to the performance attribute type; and
a server controller programmed, when executed by the processor, to:
identify the target dataset,
identify the benchmark attribute type in at least one of the first subcluster and the second subcluster,
identify the outlier value for the benchmark attribute type, and
return the benchmark attribute type and the outlier value.

12. The system of claim 11, wherein returning the benchmark attribute type and the outlier value comprises:
adjusting a parameter of the server controller according to at least one of the benchmark attribute type and the outlier value.

13. The system of claim 11, wherein returning the benchmark attribute type and the outlier value further comprises:
predicting an action to change a target value of the target attribute type; and
presenting the action.

14. The system of claim 11, wherein the first clustering model, when executed by the processor, is further programmed to generate the cluster of datasets by:
comparing, to determine a plurality of distances, i) target values of the plurality of similar attribute types for the target dataset to ii) corresponding values of the plurality of similar attribute types for remaining datasets in the plurality of datasets; and
identifying the cluster of datasets as ones of the remaining datasets for which the plurality of distances satisfy a threshold distance.

15. The system of claim 11, wherein the second clustering model, when executed by the processor, is further programmed to generate the first subcluster and the second subcluster by:
clustering the cluster of datasets according to selected attribute values of a selected attribute type among the plurality of similar attribute types.

16. The system of claim 11, wherein identifying the outlier value comprises one of:
identifying a highest benchmark value of the benchmark attribute type for a selected dataset in the at least one of the first subcluster and the second subcluster, wherein the outlier value comprises the highest benchmark value; and
identifying a plurality of benchmark values of the benchmark attribute type for datasets in the at least one of the first subcluster and the second subcluster, wherein the plurality of benchmark values satisfy a threshold value, and wherein the plurality of benchmark values comprise the outlier value.

17. The system of claim 11, wherein identifying the target dataset comprises:
receiving a query requesting the target dataset be compared to the plurality of datasets.

18. The system of claim 11, wherein identifying the benchmark attribute type comprises:
receiving the benchmark attribute type from a query requesting the target dataset be compared to the plurality of datasets.

19. The system of claim 11, wherein identifying the benchmark attribute type comprises:
identifying a selected dataset in the first subcluster or the second subcluster, wherein the selected dataset comprises a selected attribute type of the plurality of similar attribute types that has a selected attribute value above a threshold value, and
specifying the selected attribute type as the benchmark attribute type.

20. A method comprising:
identifying a target dataset within a plurality of datasets, wherein each of the plurality of datasets comprises a plurality of similar attribute types;
applying a first clustering model to the plurality of datasets and the target dataset to generate a cluster of datasets comprising fewer datasets than the plurality of datasets, wherein applying the first clustering model further comprises:
comparing, to determine a plurality of distances, i) target values of the plurality of similar attribute types for the target dataset to ii) corresponding values of the plurality of similar attribute types for remaining datasets in the plurality of datasets, and
identifying the cluster of datasets as ones of the remaining datasets for which the plurality of distances satisfy a threshold distance;
applying a second clustering model to the cluster of datasets to generate a first subcluster of the cluster of datasets and a second subcluster of the cluster of datasets by clustering according to a performance attribute type different than the similarity attribute type, wherein applying the second clustering model further comprises:
clustering the cluster of datasets according to selected attribute values of a first selected attribute type among the plurality of similar attribute types;
identifying a benchmark attribute type, comparable to a target attribute type of the target dataset, in at least one of the first subcluster and the second subcluster,
wherein the similarity attribute type, the performance attribute type, the benchmark attribute type, and the target attribute type are members of the plurality of similar attribute types, and
wherein identifying the benchmark attribute type comprises identifying a first selected dataset in the first subcluster or the second subcluster, wherein the first selected dataset comprises a second selected attribute type of the plurality of similar attribute types that has a selected attribute value above a threshold value, and
specifying the second selected attribute type as the benchmark attribute type;
identifying an outlier value for the benchmark attribute type of an outlier dataset in the at least one of the first subcluster and the second subcluster, wherein identifying the outlier value comprises identifying a highest benchmark value of the benchmark attribute type for a second selected dataset in the at least one of the first subcluster and the second subcluster, wherein the outlier value comprises the highest benchmark value; and
adjusting a parameter of a server controller according to at least one of the benchmark attribute type and the outlier value.
